(19) United States
(12) Patent Application Publication
(10) Pub. No.: US 2011/0204046 A1
(43) Pub. Date: Aug. 25, 2011

(54) Microwave Heating Construct for Frozen Liquids and Other Items

(76) Inventors: Scott W. MIDDLETON, Oshkosh, WI (US); Lorin R. Cole, Larsen, WI (US); Patrick H. Wnek, Sherwood, WI (US)

(21) Appl. No.: 13/084,764

(22) Filed: Apr. 12, 2011

Related U.S. Application Data
(63) Continuation-in-part of application No. 12/291,563, filed on Nov. 12, 2008, now abandoned.
Application No. 12/291,563 is a division of application No. 11/440,921, filed on May 25, 2006, now Pat. No. 7,476,830.
(60) Provisional application No. 60/684,490, filed on May 25, 2005.

(51) Int. Cl. H05B 6/80

(52) U.S. Cl. 219/730

(57) ABSTRACT

Various constructs and methods are provided for heating a plurality of different food items to their respective desired serving temperatures in a microwave oven in about the same amount of time.

### CROSS-REFERENCE TO RELATED APPLICATIONS

This application is a continuation-in-part of U.S. patent application Ser. No. 12/291,563, filed Nov. 12, 2008, which is a divisional of U.S. patent application Ser. No. 11/440,921, filed May 25, 2006, now U.S. Pat. No. 7,476,830, which claims the benefit of U.S. Provisional Application No. 60/684,490, filed May 25, 2005, all of which are incorporated by reference herein in their entirety.

### BACKGROUND

There has been a long-felt need for microwavable packages for heating different food items within the same amount of time. Typically, microwavable frozen entrees have been limited to selections of solid food items that heat at a similar rate in a microwave oven. Liquid food items generally have not been included in such products because frozen liquid food items, such as frozen beverages and soups, require a relatively large amount of time and microwave energy to thaw and reach serving temperature, which typically is about 160° F. to 200° F. As a result, by the time the liquid food item reaches its desired serving temperature, any solid food items heated concurrently with the liquid food item may be overdried, hardened, and/or inedible. Thus, there remains a need for microwave packages or other constructs that provide even heating of various types of food items, for example, frozen liquid food items and frozen solid food items (e.g., a soup and a sandwich), to be heated together in a microwave oven. There is further a need for microwave packages or other constructs that accelerate the heating of frozen liquid food items in a microwave oven.

### SUMMARY

In one aspect, this disclosure is directed to a microwave heating apparatus or construct or apparatus for, and method of, heating a frozen liquid or semi-liquid (collectively “liquid”) food item in a microwave oven. The construct includes a susceptor for being in close proximity to the frozen liquid food item. As the susceptor becomes hot in response to microwave energy, the heat transfers to the frozen liquid food item, which causes the frozen food item to thaw in the areas proximate to the susceptor. As the frozen liquid thaws, the dielectric constant (and hence loss tangent) of the thawing frozen liquid increases. The thawed frozen liquid can then be heated directly by the microwave energy and any additional sensible heat from the susceptor. The heat from the thawed frozen liquid then can then be transferred to the adjacent frozen liquid food item to further the thawing and heating process. As a result, the heating of the frozen liquid food item is accelerated, as compared with a construct without a susceptor.

In another aspect, this disclosure is directed generally to various trays, packages, systems, or other constructs (collectively “constructs”), various methods of making such constructs, and various methods of heating, browning, and/or crisping at least one food item in a microwave oven. The various constructs may be used to heat a plurality of food items concurrently, where at least two of the food items respond differently to microwave energy. In this aspect, the present invention seeks to address the special problem of trying to heat a frozen liquid food item with other food items in a microwave oven. Frozen liquid food items respond to microwave energy differently than frozen solid food items, in part because frozen liquid food items undergo a phase transition that require a certain amount of thermal energy. When solid and liquid food items are heated concurrently, the liquid food item often requires a significantly longer heating time to attain the desired serving temperature. As a result, by the time the liquid food item is suitably heated, the solid food item is often overdried, hard, and inedible.

In this aspect, the construct may include one or more features that allow the plurality of food items to reach their respective desired serving temperatures in substantially the same amount of time. Some of such features may reflect, absorb, or direct microwave energy. Additionally, the construct may include portions that are transparent to microwave energy. As used herein, “desired serving temperature” refers to a desired heating temperature, a desired consumption temperature, or any temperature therebetween. Thus, it will be understood that although the desired heating temperature may be slightly higher or lower than the desired serving temperature, both of such temperatures and the temperatures therebetween are encompassed by the term “desired serving temperature” or simply “desired temperature”.

More particularly, the present inventors have discovered that a susceptor may be used to address the unique problem of concurrently heating a frozen liquid food item with a frozen solid food item. Although susceptors are used widely throughout some of the cited references and numerous others to enhance the browning and/or crisping of solid food items, none of the references recognize the special problem of heating frozen liquid food items and frozen solid food items simultaneously in a microwave oven. Further, none of the references contemplate using a susceptor to address this problem. However, the present inventors have discovered that an appropriately positioned susceptor may accelerate the heating of the frozen liquid food item, while other microwave energy interactive element(s) may be used to increase or decrease the rate of heating of all or a portion of the solid food item, so that both items can be properly heated together in a microwave oven.

The principles described herein may be used with numerous combinations of food items. By way of illustration, and not limitation, some combinations may include a sandwich and soup, a meat with gravy, a potato with sour cream, pasta with marinara, French fries with ketchup, a hot dog with chili topping, an egg roll with dipping sauce, vegetables with cheese sauce, a bread pudding with chocolate sauce, turkey with cobbler, and so on.

Additional aspects, features, and advantages of the present invention will become apparent from the following description and accompanying figures.

### BRIEF DESCRIPTION OF THE DRAWINGS

The description refers to the accompanying drawings, some of which are schematic, in which like reference characters refer to like parts throughout the several views, and in which:

FIG. 1A schematically illustrates the heating of a frozen liquid food item using a susceptor according an aspect of the present disclosure;

FIG. 1B schematically illustrates a cross-sectional view of a microwave heating construct for employing the sequential heating process of FIG. 1A;

FIG. 2 is a Rieke diagram for an exemplary magnetron used in a conventional microwave oven;

FIG. 3 schematically depicts a tray used to create a microwave heating model to demonstrate various aspects of the invention;

FIG. 4A schematically illustrates the temperature distribution of a plain microwave heating tray of FIG. 3, after 300 seconds of heating;

FIG. 4B schematically illustrates the temperature distribution of a microwave heating tray of FIG. 3 including a susceptor, after 300 seconds of heating;

FIG. 4C presents comparative heating data for a plain tray and a tray with a susceptor;

FIG. 5A schematically depicts an exemplary microwave heating construct for heating a plurality of food items;

FIG. 5B schematically depicts another exemplary microwave heating construct for heating a plurality of food items, which is a variation of the construct of FIG. 5A;

FIG. 6A schematically depicts yet another exemplary microwave heating construct for heating a plurality of food items;

FIG. 6B schematically depicts still another exemplary microwave heating construct for heating a plurality of food items, which is a variation of the construct of FIG. 6A;

FIG. 7 schematically depicts yet another exemplary microwave heating construct for heating a plurality of food items;

FIG. 8 schematically depicts still another exemplary microwave heating construct for heating a plurality of food items;

FIG. 9 presents heating data for frozen and liquid water in plain trays and susceptor trays in a microwave oven;

FIGS. 10-12 schematically depict exemplary blanks for forming trays used to conduct various product evaluations in Example 2;

FIG. 13 schematically depicts an exemplary tray that may be formed from the blanks of FIGS. 10-12;

FIG. 14 schematically depicts a patterned segmented foil used to conduct various product evaluations in Example 2;

FIG. 15A schematically depicts a cross-sectional view of an exemplary microwave energy interactive insulating material that may be used to form a microwave heating construct;

FIG. 15B schematically depicts the exemplary microwave energy interactive insulating material of FIG. 15A, in the form of a cut sheet; and

FIG. 15C schematically depicts the exemplary microwave energy interactive insulating sheet of FIG. 15B, upon exposure to microwave energy.

### DESCRIPTION

In one aspect, this disclosure is directed to a microwave heating construct or apparatus for heating a frozen liquid (or semi-liquid) food item in a microwave oven. As used herein, a liquid or semi-liquid (collectively referred to herein as “liquid”) comprises any non-solid, non-gaseous fluid that tends to flow. The liquid may be Newtonian or non-Newtonian, and may include solid components or particulates. Examples of liquid food items may include, but are not limited to, beverages, soups, stews, sauces, gravies, condiments, compotes, puddings, and custards.

The construct or apparatus includes a susceptor that is positioned within the construct to be in close proximity to the frozen liquid food item. A susceptor is a thin layer of microwave energy interactive material that tends to absorb at least a portion of impinging microwave energy and convert it to thermal energy (i.e., sensible heat) through resistive losses in the layer of microwave energy interactive material. The remaining microwave energy is either reflected by or transmitted through the susceptor. Although countless possibilities are contemplated, the susceptor may comprise a layer of aluminum, generally less than about 500 angstroms in thickness, for example, from about 60 to about 100 angstroms in thickness, and having an optical density of from about 0.15 to about 0.35, for example, about 0.17 to about 0.28. Such materials have been used widely to promote browning and/or crisping of the surface of solid foods, but they have typically not been thought of as having any relevance to the bulk heating of fluids. In fact, since susceptors tend to reflect a portion of microwave energy, susceptors have typically been believed to be a hinderance to bulk heating applications. However, in contrast to the widely accepted thinking that the utility of susceptors is limited to surface browning and crisping applications, the present inventors have discovered that a susceptor can accelerate the bulk heating of frozen liquid food items.

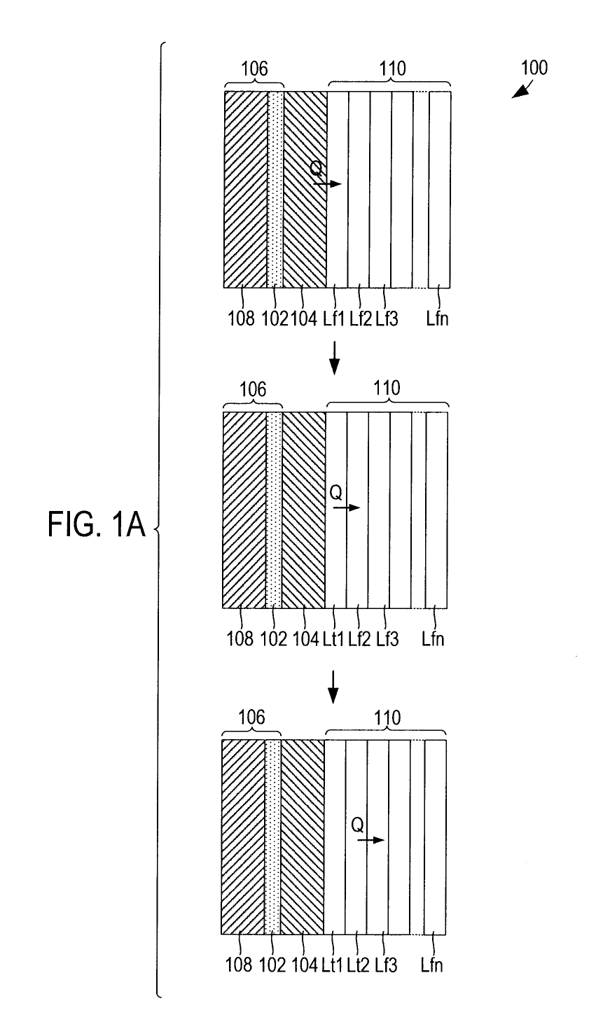

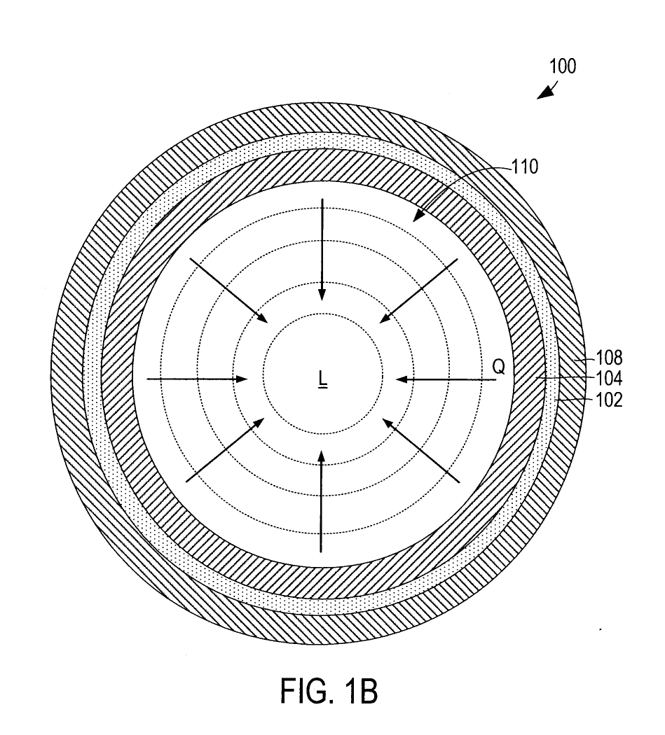

FIG. 1A schematically illustrates a partial cross-sectional view of a portion of an exemplary microwave heating construct 100 (e.g., a wall of a construct). The construct 100 includes a layer of microwave energy interactive material 102 (i.e., a susceptor 102) supported on a microwave energy transparent substrate 104, for example, a polymer film to define a susceptor film 106. The susceptor 102 is joined to a dimensionally stable support layer 108 (e.g., paper or paperboard) using an adhesive or other suitable material (not shown). A frozen liquid food item may be contained within the interior (generally indicated at 110) of the construct 100. For purposes of illustration, and not limitation, the frozen food item is schematically illustrated as a plurality of adjacent regions Lf1, Lf2, Lf3 . . . Lfn. Prior to exposing the food item in the construct to microwave energy, the frozen liquid Lf1, Lf2, Lf3 . . . Lfn has a dielectric constant ε1 and loss tangent tan δ1 (where tan δ1 is a parameter of a dielectric material that quantifies its inherent dissipation of electromagnetic energy).

Upon exposure to microwave energy in a microwave oven, the susceptor 102 begins to convert a portion of the microwave energy into thermal energy Q (i.e., heat). The heat Q from the susceptor 102 may then be transferred to the adjacent frozen liquid Lf1, which causes the frozen liquid Lf1 to begin to thaw. As the frozen liquid Lf1 thaws, the dielectric constant and loss tangent of the thawing frozen liquid increase until the liquid is completely thawed. The thawed liquid Lt1 has a dielectric constant ε2 and loss tangent tan δ2, where ε2 is greater than ε1, and tan δ2 is greater than tan δ1. The thawed frozen liquid Lt1 can then be heated directly by the microwave energy (in addition to the sensible heat from the susceptor). By way of illustration, and not limitation, in the frozen state, pure water has a very low dielectric constant and loss factor. By contrast, liquid water is orders of magnitude more lossy, as shown in the Table 1. Thus, heating of the food item accelerates when the frozen liquid is thawed.

TABLE 1

| | Ice | Water (0° C.) | Water (100° C.) |
|---|---|---|---|
| Dielectric constant (ε) | 3.2 | 88 | 55 |
| Loss tangent (tan δ) | 0.0009 | 0.157 | 0.157 |

Still viewing FIG. 1A, as the thawed liquid Lt1 heats, the heat Q from the liquid Lt1 then can then be transferred to the adjacent frozen liquid food item Lf2. As the frozen liquid Lf2 thaws, the dielectric constant and loss tangent of the thawing frozen liquid increase until the liquid is completely thawed, as described above. The thawed frozen liquid Lt2 then can be heated directly by the microwave energy. As the liquid Lt2 heats, the heat Q from the liquid Lt2 can then be transferred to the adjacent frozen liquid food item Lf3, and so on, to further the thawing and heating process, until the entire liquid Lfn is thawed and heated to the desired temperature. Thus, the use of a susceptor 102 in this manner significantly reduces the time needed to thaw the frozen liquid food item and heat it to the desired serving temperature, as compared with a construct without a susceptor.

The sequential thawing and heating principles schematically illustrated in FIG. 1A may be applied to any construct geometry. For example, FIG. 1B schematically illustrates a cross-sectional view of an exemplary microwave heating construct 100 having a generally cylindrical shape, for example, a cup or bowl. As shown in FIG. 1B, during microwave heating, heat Q is transferred radially from the outer regions of the food item inwardly until the entire food item L is thawed, as described in connection with FIG. 1A.

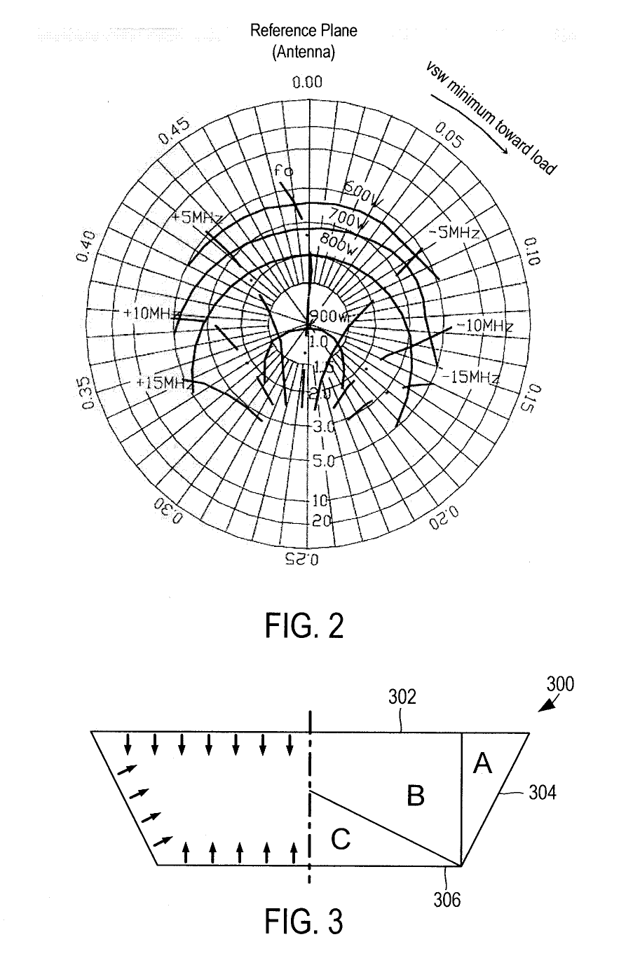

The present inventors have also recognized that the use of a susceptor to heat a frozen liquid in this manner has a synergistic effect with the inherently reactive properties of a microwave oven. For example, FIG. 2 illustrates a Rieke diagram for a typical magnetron used in a domestic microwave oven. The positions on the polar display represent different loads on the magnetron (i.e., from the cavity of the microwave oven). The radial position represents the voltage standing wave ratio (VSWR), the ratio of the magnitude of the adjacent anti-nodes in the interference pattern formed when an incident microwave interferes with a reflection of itself. A low VSWR means that power is transmitted well, with a perfect transmission being referred to as having a “matched” state. As shown, the VSWR goes from a good match at the center to a very poor match at the perimeter (i.e., approaching full reflection), whereas the circumferential position represents the phase of the load.

The roughly radial (broken) lines on the chart represent lines of equal frequency and show how the oscillating frequency of the magnetron is affected by the magnitude and phase of the load. The full circular lines represent lines represent operating points of equal power. Notably, the oven power delivery is heavily influenced by the nature of the load. The iso-power lines on the chart show that the power delivery (for this particular magnetron) varies from 600 W to 900 W as the VSWR improves. An unloaded microwave oven cavity will be highly reflective (as the walls are all metal and so the power delivery will be very low), which represents a high VSWR. As more absorptive loads are added (such as the glass turntable tray, food, etc.), the VSWR as seen by the magnetron will improve and the forward power delivery will increase as the load conditions move towards the centre of the Rieke diagram.

Thus, for example, in the case of water (Table 1), a frozen water load looks like a very poor load to the magnetron and the power delivery will be low. As the ice melts, the load becomes much more lossy and the power delivery will increase. Unlike the ice, a susceptor will absorb microwave energy at freezer temperatures and provide a hot surface in contact with the frozen fluid. That hot surface will cause a much faster melting of the frozen fluid close to the susceptor. The melted material then starts to absorb microwave energy faster as the dielectric absorption increases by orders of magnitude. To further complement this process, the greater absorbing load results in a better match as seen by the magnetron and so the forward power delivery increases. Thus, the susceptor causes the power delivery to the load to be enhanced and the heating time to decrease. This is a significant and novel use for a susceptor which has primarily only been thought of for use with browning and crisping solid food items. A two-dimensional finite element analysis was used to further examine the benefits of using a susceptor to heat a frozen liquid. A tray 300 having the following dimensions was used: 130 mm top diameter, 90 mm base diameter, 40 mm height, as illustrated in FIG. 3. The tray was viewed as a load with uniform surface impingement of the microwaves. The microwaves are approximated to be normal to the surface, as shown on the left side of FIG. 3. The decay of the microwaves within the tray was characterized by a spatial variation dependent on the x/y position.

To generate the heating profile, the food item within the tray was broken into three regions A, B, C as shown on the right hand side of FIG. 3, with each region being subject to a different combination of exposure, as set forth in Table 2.

TABLE 2

| Region | Top 302 | Sidewall 304 | Base 306 |
|---|---|---|---|
| A | Yes | Yes | No |
| B | Yes | Yes | Yes |
| C | Yes | No | Yes |

The decay of microwave power level as it propagates through a lossy medium is exponential and is defined by:

Pₓ=Ae^{-x}/D

where D is the penetration depth (i.e. the distance over which the power decays to 1/e), and A represents the initial power at the pie surface. For the purposes of this model, A was defined as the surface power density measured in W/m². Hence the power lost/dissipated in any given interval ∂x is simply:

$$\frac{\partial {P}_{x}}{\partial x} = - \frac{A}{D} {e}^{- x / D}$$

From this, a spatial power delivery for each segment was derived. No account was made for internal reflections where the food cross-section dimension was less the penetration depth. (This would only be the case at the outside top section of the food item). The surface power density A was assigned by estimating by calorimetry that the power delivery to a representative pie would be about 600 W. For an outside surface area of the pie of 35×10³ mm², this gives an average surface power density of 1.7×10⁻² W/mm².

Since the spatial power distribution could not account for local dependencies on temperature, the value of the penetration depth D was set to a fixed value of 20 mm. This value was chosen by review of the various penetration depth data published in Industrial Microwave Heating (Meredith and Metaxis) and represents the penetration depth of 2.45 GHz radiation in pure water at 40° C. Since the penetration depth in ice would be much greater, this is a conservative estimate that tends to reduce the predicted benefit of the susceptor.

The general physical properties were taken from publicly available data and were set to the values shown in Table 3. The convection cooling rate was taken from previously verified models prepared by the assignee of the present application.

TABLE 3

| Property | Assigned value | Units |
|---|---|---|
| Heat capacity in the thawed state | 4.2 | J/g/K |
| Density | 1.0 | g/cc |
| Conductivity | 2.2 | W/K/m |
| Convection cooling rate | 11.0 | W/K/m² |

The high free water content of items such as a soup would result in distinct phase transitions which would have associated latent heats much greater than the specific heat capacities within a given state. From the perspective of the model, the heat capacity of the test material would appear to have a spike at 0° C. and at 100° C. to represent the latent heat of fusion and evaporation. However, since a finite element analysis will not converge if the material properties have very high rates of change, it was necessary to smooth out the transition between states such that the transition between states occurs over a broader temperature range, but the total energy associated with the transition changes is correct when integrated over that broader range. Spatial algorithms were then derived as set forth in Table 4.

TABLE 4

| Power component | Algorithm |
|---|---|
| Power from the | 8.5e\hat{ }5*e\hat{ }(−x/0.02) |
| base | |
| Power from the lid | 8.5e5*e\hat{ }((x − 0.04)/0.02) |
| Power from walls | 7.6e5*e\hat{ }(−(0.045 + x/2 − y)/0.022)*(45 + 0.5*x)/y |
| | Further approximated to: |
| | 7.6e5*e\hat{ }(−(0.045 + x/2 − y)/0.022)*(2.8 − 0.04y) |

It will be noted that the above model applies to a generally cylindrical symmetry. In a radial slice, x defines the coordinate along the axis (where x=0 mm at the base and x=40 mm at the top surface) and y defines the radial distance from the axis. It will also be noted that the term (45+0.5x)/y in the wall power algorithm accounts for the intensification resulting from the radial convergence of the microwave power. This expression cannot be used in the model as it tends to infinity when y goes to zero at the axis of the pie. Given that the penetration depth was far less than the food radius, this expression was replaced by (2.8−0.4y), which is a good linear approximation over the first 20 mm of penetration. This substitution avoids the divide by zero problems in the model and leads to the following composite power dissipation algorithms for the regions (dimensions of W/m³ when x and y are expressed in mm), as set forth in Table 5.

TABLE 5

| Region | Algorithm |
|---|---|
| A | 8.5e5*e\hat{ }((x − 0.04)/0.02) + 7.6e5*e\hat{ }(−(0.045 + x/2 − y)/ |
| | 0.022)*(2.8 − 0.04y) |
| B | 8.5e\hat{ }5*e\hat{ }(−x/0.02) + 8.5e5*e\hat{ }((x − 0.04)/0.02) + |
| | 7.6e5*e\hat{ }(−(0.045 + x/2 − y)/0.022)*(2.8 − 0.04y) |
| C | 8.5e\hat{ }5*e\hat{ }(−x/0.02) + 8.5e5*e\hat{ }((x − 0.04)/0.02) |

For the tray with a susceptor, the model was altered to have surface power dissipation at the walls and base. A typical susceptor has a distinct (and desirable) thermal tolerance. In this application, the susceptor is in very good thermal contact with the load and so the self-limiting temperature of the susceptor is not expected to be reached. A typical susceptor is measured (using a vector network analyzer) as having 40% power absorption. Therefore, the model of the susceptor tray was set to have surface power dissipation of 6480 W/m² based on empirical data gathered from calorimetric experimentation by the assignee of the present application.

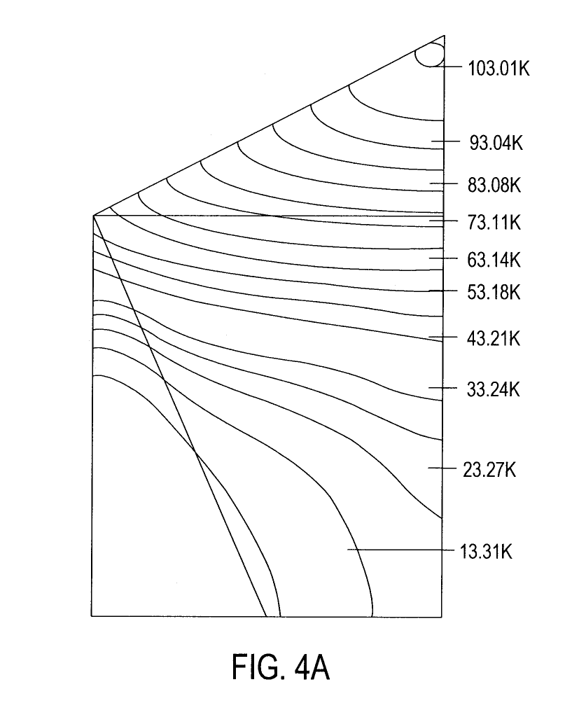

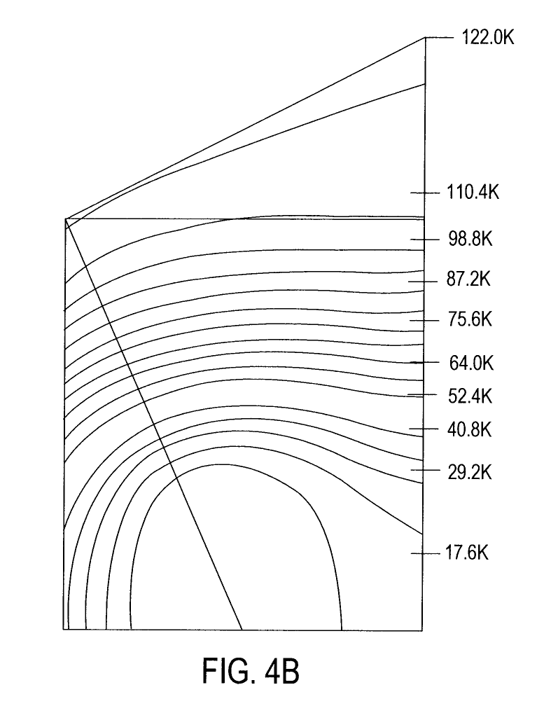

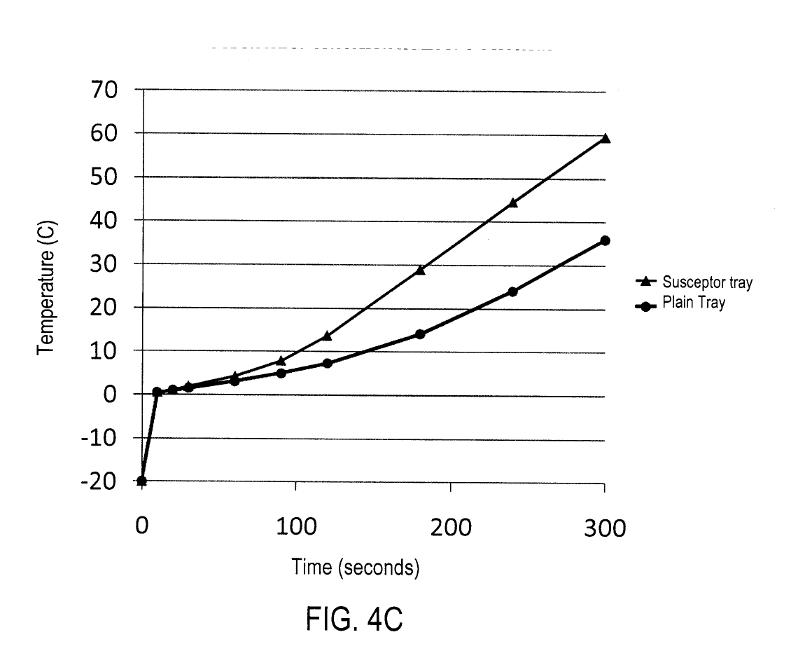

FIGS. 4A and 4B respectively illustrate thermal maps of the temperature distribution in the plain tray and susceptor tray after 300 seconds of heating. (Note that the scale is temperature rise from a starting temperature of −20° C., i.e., not the absolute temperature). The thermal maps of FIGS. 4A and 4B illustrate that the susceptor tray delivers a much better temperature distribution. It should also be noted that each simulation suggests that some unthawed material will exist at the end of the simulated cycle. However, in practice, an ice block would float to the surface of the tray and see a greater power exposure to assist with thawing. Thus, while the simulations are conservative, the comparison between the plain tray and susceptor tray is still valid.

FIG. 4C schematically illustrates the integrated temperature rise of the tray contents in the plain and susceptor trays (integrated across the model slice as opposed to a three dimensional integration). As will be apparent, the susceptor tray delivers a significantly enhanced heating rate.

There are several practical implications of the present discoveries. First, it is possible to accelerate the heating of a frozen liquid food item in a microwave oven, as compared with conventional constructs without susceptors. This is surprising and unexpected. Prior to the present invention, the conventional belief has been that frozen liquids heat sufficiently on their own (i.e., without the use of a susceptor) and that there is no need to accelerate heating. Further, as stated above, since susceptors tend to reflect a portion of microwave energy, it has conventionally been believed that using a susceptor to heat a frozen liquid would actually decrease the rate of heating. Thus, the present invention is contrary to the conventional approaches to heating frozen liquids in a microwave oven.

Second, as a further result of this discovery, the present inventors have determined that frozen liquids may be successfully heated concurrently with other, non-liquid food items. When a frozen liquid food item is heated with a frozen solid food item without a susceptor, the solid food item typically becomes dried out and inedible by the time the liquid food item is heated. However, by accelerating the thawing of the frozen liquid according to the present invention, a frozen liquid food item can be heated with other food items so that all of the food items are suitably heated within about the same amount of time.

The principles described above may be embodied in countless microwave heating constructs or systems. The present invention is not limited to any particular construct or system geometry or configuration. The constructs may include trays, sleeves, cartons, pouches, wraps, or any other container or package. The various constructs or systems may be formed from any suitable material or combination of materials or components, including both microwave energy interactive components and microwave energy inactive or transparent components. For example, when it is desired to heat a plurality of frozen food items, where at least one of the food items is substantially a liquid at its desired temperature and at least one of the food items is substantially a solid at its desired serving temperature, a microwave heating construct may include a susceptor for heating the frozen liquid food item and one or more microwave energy interactive elements that alter the effect of microwave energy on the solid food item. Such elements may include a susceptor (e.g., for browning and/or crisping), a microwave energy shielding element (e.g., for reflecting microwave energy to prevent overheating or overdrying of all or a portion of the solid food item), a microwave energy directing element (e.g., for directing microwave energy to one or more areas that might otherwise be prone to underheating), or any combination of such elements. Further, the susceptor used to heat the frozen liquid may be coupled with other microwave energy interactive elements and/or microwave energy transparent areas to fine tune the heating of the liquid food item.

Likewise, the various constructs and systems may have any suitable configuration. In one example, a construct or system for heating a plurality of food items in a microwave oven may comprise a first compartment and a second compartment, both of which include microwave energy interactive material configured as one or more microwave energy interactive elements. The microwave energy interactive elements of the first and second compartments are independently configured selected so that food items within the first compartment and the second compartment are heated to their desired respective temperatures in substantially the same amount of time.

In one variation, the first compartment may be configured to receive a liquid food item in a frozen state, for example, a beverage, soup, stew, sauce, gravy, condiment, compote, pudding, or custard, and the second compartment may be configured to receive a solid food item in a frozen state, for example, a dough-based or breaded food item, such as a sandwich or breaded meat. The microwave energy interactive element of the first compartment may comprise a susceptor (with or without microwave energy transparent areas within the susceptor), a segmented foil at least partially overlying a susceptor, or any combination thereof. The microwave energy interactive element of the second compartment may comprise a segmented foil, a shielding element, a susceptor (which may comprise a portion of a microwave energy interactive insulating material), or any combination thereof.

In some embodiments, the first compartment may include a container (which may be removable) for containing the liquid food item. The microwave energy interactive element(s) of the first compartment may be mounted on the container if desired. Likewise, in some embodiments, the second compartment may include a sleeve, pouch, or wrap for receiving the second food item. If desired, the microwave energy interactive element(s) of the second compartment may be mounted on the sleeve, pouch, or wrap.

If desired, the construct may include an overwrap overlying at least one of the first compartment and the second compartment. In one embodiment, the overwrap comprises a flexible material, for example, a polymer film. The overwrap may include microwave energy interactive material configured as a shielding element, a segmented foil, a susceptor, or any combination thereof. In one example, the overwrap includes a microwave energy interactive element overlying the second compartment. Other variations are contemplated. In some embodiments, the overwrap may be replaced with a dimensionally stable sleeve or sheath for receiving the tray. The sleeve may be provided with microwave energy interactive elements as described above.

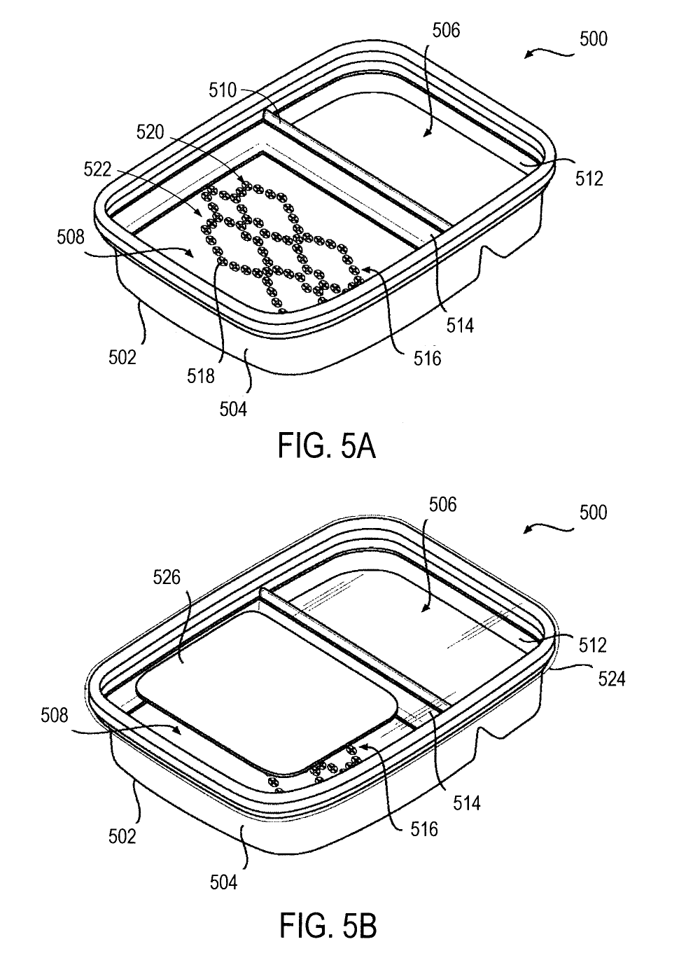

FIGS. 5A-8 illustrate various exemplary microwave heating constructs or systems for concurrently heating a plurality of food items (not shown) in a microwave oven. The illustrated constructs or systems each include at least two portions, sections, or compartments for receiving different food items. Each compartment includes microwave energy interactive material configured as one or more microwave energy interactive elements that are selected so that the food items in the first compartment and the second compartment are heated to their respective desired serving temperatures in substantially the same amount of time. The particular microwave energy interactive elements used may depend on numerous factors, including the size and type of food items to be heated, the desired serving temperatures, and so on. Thus, it will be appreciated that any of the numerous microwave energy interactive elements described herein or contemplated hereby may be used in any combination, arrangement, or configuration as needed or desired for a particular application. Further, although several different exemplary aspects, implementations, and embodiments of the various inventions are provided, numerous interrelationships between, combinations thereof, and modifications of the various inventions, aspects, implementations, and embodiments of the inventions are contemplated hereby.

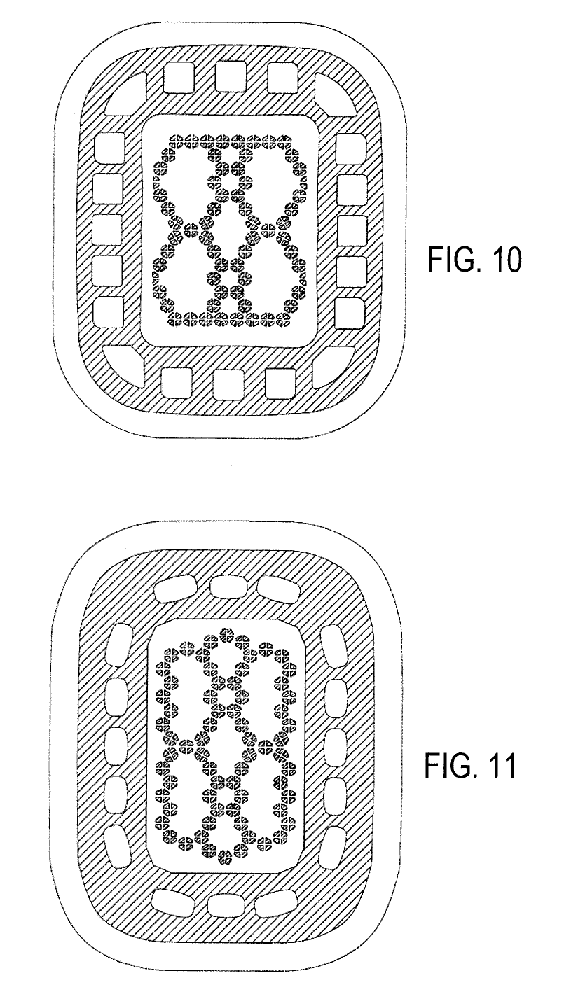

Turning now to FIGS. 5A and 5B, an exemplary microwave heating construct 500 comprises a tray including a base 502 and an upstanding peripheral wall 504. The construct 500 includes a plurality of compartments, for example, a first compartment 506 and a second compartment 508, separated from one another by an interior wall 510. The first compartment 506 and second compartment 508 each comprise microwave energy interactive material. Specifically, in this example, the first compartment 506 includes a susceptor 512 mounted on the base 502 and walls 504, 510 that define the first compartment 506. The second compartment 508 includes a microwave energy shielding element 514 mounted to at least a portion of the walls 504, 510 that define the second compartment 508, and a microwave energy directing element 516 mounted to the base 502 within the second compartment 508. The microwave energy directing element 516 comprises a plurality of spaced apart metallic foil segments 518 arranged in a plurality of clusters 520. Each cluster 520 comprises four metallic segments 518, each resembling a quadrant of a circle. In this example, the clusters are arranged in a lattice-like configuration to define a plurality of loops or rings 522. However, other configurations are contemplated (see, e.g., FIGS. 10-12).

To use the construct 500, a frozen liquid food item may be placed into (or provided in) the first compartment 506 and a frozen solid food item may be placed into (or provided in) the second compartment 508. When the food items within the construct 500 are exposed to microwave energy, the susceptor 512 of the first compartment 506 decreases the overall heating time of the liquid food item (as compared with a compartment or container without a susceptor 512). At the same time, the shielding element 514 of the second compartment 508 reduces transmission of microwave energy to prevent overdrying of a peripheral portion of the solid food item, and the microwave energy directing element 516 directs microwave energy towards the center of the bottom of the solid food item to facilitate heating. As a result, both items can be heated evenly and properly in about the same amount of time.

In this and other embodiments, a partial or complete overwrap 524, for example, a polymer film, may overlie all or a portion of the tray 500, as shown in FIG. 5B. The overwrap may be one that is intended to be pierced, or removed partially, or completely prior to heating in a microwave oven. If desired, the overwrap 524 may include microwave energy interactive material configured as a microwave energy interactive element to enhance the heating, browning, and/or crisping of one or more of the various food items being heated in the tray 500. In the illustrated example, the overwrap 524 includes a microwave energy shielding element 526 overlying the second compartment 508 to further prevent the solid food item from overheating over overdrying. However, other possibilities are contemplated.

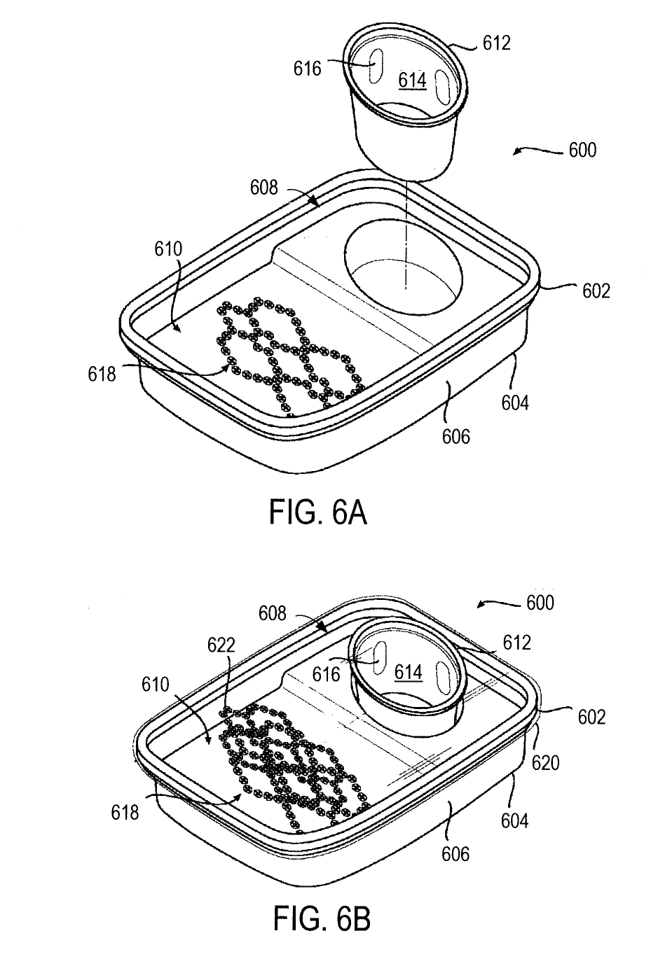

FIGS. 6A and 6B schematically illustrate another exemplary microwave heating system 600 for heating a plurality of food items. The construct or system 600 comprises a tray 602 including a base 604 and an upstanding peripheral wall 606. The tray 602 includes a plurality of cavities or compartments, for example, a first compartment 608 and a second compartment 610. The system 600 also includes a container 612 (e.g., a cup or bowl) dimensioned to be removably seated within the first compartment 608.

The first compartment 608 and second compartment 610 each comprise microwave energy interactive material. Specifically, in this example, the first compartment 608 includes a susceptor 614 mounted to the container 612. The susceptor 614 may be mounted to the container 612 on a side of the container facing the cavity or interior space of the container. The susceptor 614 surrounds or circumscribes a plurality of microwave energy transparent areas or apertures 616. In this example, the microwave energy transparent areas 616 have a somewhat elongated or obround shape. However, different configurations of microwave energy transparent areas 616 may be used. The second compartment 610 includes a microwave energy directing element 618 mounted to the base 604 of the second compartment 610. The microwave energy directing element 618 may be similar to the microwave energy directing element 516 of FIGS. 5A and 5B, as shown, or may have any other suitable configuration.

To use the construct 600, a frozen liquid food item may be placed into or provided in the first compartment 608 and a frozen solid food item may be placed into or provided in the second compartment 610. When the food items within the construct 600 are exposed to microwave energy, the susceptor 614 of the first compartment 608 accelerates the heating of the liquid food item, as described above. Further, microwave energy transparent areas 616 provide bulk heating of the liquid food item. At the same time, the microwave energy directing element 618 facilitates heating of the central bottom of the solid food item. As a result, both items can be heated evenly and properly in about the same amount of time.

As shown in FIG. 6B, a partial or complete overwrap 620 may overlie all or a portion of the tray 602 prior to and/or during heating. In this example, the overwrap 620 overlies the top of the first compartment 608 and the second compartment 610. The overwrap 620 includes a microwave energy interactive material, in this example, configured as a microwave energy directing element 622 including plurality of segmented foil loops supported on a polymer film. The microwave energy directing element 622 may be configured similarly to microwave energy directing element 618, as shown, or may be configured differently. In this example, the microwave energy directing element 622 overlies only the second compartment 610. However, other possibilities are contemplated.

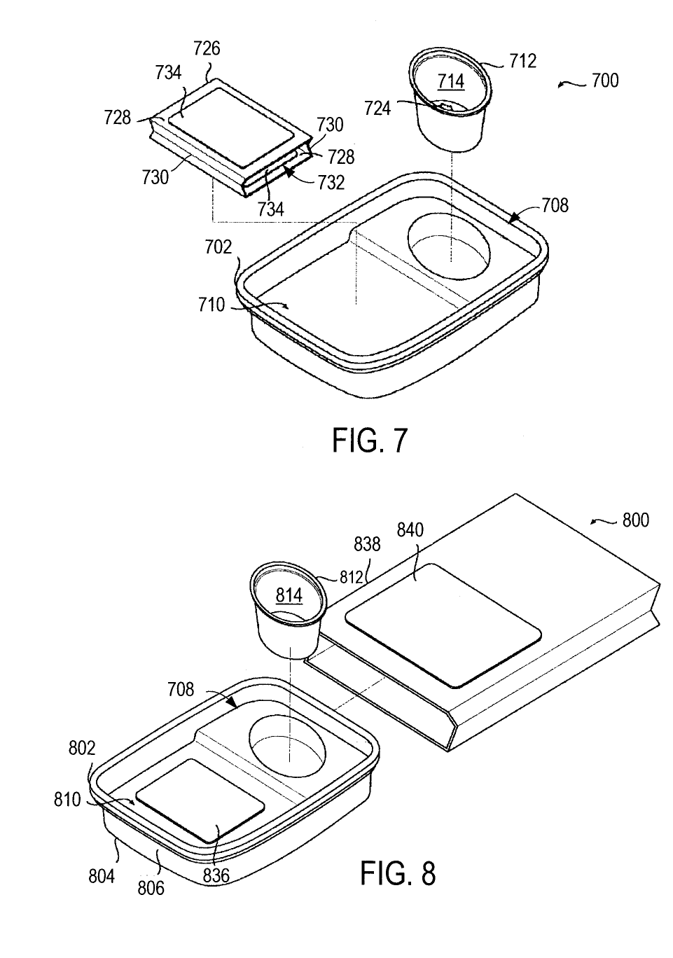

FIGS. 7 and 8 schematically depict exemplary variations of the construct or system 600 of FIG. 6A. The constructs or systems 700, 800 of FIGS. 7 and 8 include features that are similar to the construct or system 600 shown in FIG. 6A, except for variations noted and variations that will be understood by those of skill in the art. For simplicity, the reference numerals of similar features are preceded in the figures with a “7” or “8” instead of a “6”.

In the example schematically illustrated in FIG. 7, the container 712 includes a microwave energy directing element 724 (partially hidden from view) in a superposed relationship with the susceptor 714. Further, construct 700 includes a flexible or semi-rigid sleeve 726 for receiving the solid food item within the second compartment 710. The sleeve 726 generally comprises a pair of major panels 728 opposite one another and a pair of minor panels 730 opposite one another, where the major panels 728 and minor panels 730 are foldably joined to one another to define an interior space 732 for receiving the solid food item. The sleeve 726 may include one or more microwave energy interactive elements, for example, a pair of shielding elements 734, overlying the inner or outer surfaces of the respective major panels 728 of the sleeve 726. Other possibilities are contemplated. For example, in other embodiments, one face of the sleeve may include a shielding element, and the base of the first compartment may include another shielding element, microwave energy directing element, susceptor element, or any other suitable element or combination of elements.

To use the system 700, a frozen liquid food item may be placed into or provided in the container 712 in the first compartment 708 and a frozen solid food item may be placed into or provided in the sleeve 726 in the second compartment 710. When the food items within the construct 700 are exposed to microwave energy, the susceptor 714 of the container 712 in the first compartment 708 accelerates the heating of the liquid food item, as described above, with the microwave energy directing element 724 directing microwave energy to the bottom center of the frozen liquid food item. At the same time, the microwave energy shielding elements 734 of the sleeve 726 reduce heating of the solid food item to prevent overdrying. Thus, both food items can be heated evenly and properly in about the same amount of time.

In the example schematically illustrated in FIG. 8, the second compartment 810 includes a microwave energy shielding element 836 mounted to the base 804 of the second compartment 810. The system 800 also includes a sleeve or sheath 838 dimensioned to receive the tray 802. The sleeve 838 may have a configuration of panels similar to that of sleeve 726 of FIG. 7, as shown in FIG. 8, or many have any other suitable configuration. The sleeve 838 may be rigid, semi-rigid, or flexible, and may include one or more microwave energy interactive materials on an interior or exterior surface thereof for being aligned with the food items to achieve the desired heating effect. In the illustrated example, the sleeve 838 includes a microwave energy shielding element 840 for overlying the second compartment 810 when the tray 802 is positioned within the sleeve 838. However, other variations are contemplated, depending on the heating, browning, and/or crisping needs of the particular application.

Although examples of two-compartment systems are provided herein, it will be understood that numerous other systems are contemplated hereby. Other constructs or systems may include additional compartments, each of which may comprise microwave energy interactive elements that allow the food items to reach their desired respective serving temperatures in substantially the same amount of time. For example, a tray may include a compartment for each of fried chicken, a biscuit, and gravy. The fried chicken compartment may include a susceptor, the biscuit compartment may include a shielding element, and the gravy compartment may include a susceptor to accelerate thawing and heating of the gravy.

The various constructs and systems may have any shape, for example, triangular, square, rectangular, circular, oval, pentagonal, hexagonal, octagonal, or any other shape. However, it should be understood that other shapes and configurations are contemplated hereby. The shape of the construct may be determined by the shape and portion size of the food item or items being heated, and it should be understood that different packages are contemplated for different food items and combinations of food items, for example, dough-based food items, breaded food items, sandwiches, pizzas, French fries, soft pretzels, chicken nuggets or strips, fried chicken, pizza bites, cheese sticks, pastries, doughs, egg rolls, soups, dipping sauces, gravy, vegetables, and so forth.

Numerous materials may be suitable for use in forming the various constructs of the invention, provided that the materials are resistant to softening, scorching, combusting, or degrading at typical microwave oven heating temperatures, for example, at from about 250° F. to about 425° F. The materials may include microwave energy interactive material(s) configured as one or more microwave energy interactive elements that alter the effect of microwave energy on the food item and microwave energy transparent or inactive materials, typically used to form the remainder of the construct. For example, as discussed above, the microwave energy interactive material may be configured as a susceptor (e.g., susceptors 102, 512, 614, 714, 814, 1502). The microwave energy interactive material used to form a susceptor may comprise an electroconductive or semiconductive material, for example, a vacuum deposited metal or metal alloy, or a metallic ink, an organic ink, an inorganic ink, a metallic paste, an organic paste, an inorganic paste, or any combination thereof. Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof. Alternately, the susceptor may comprise a metal oxide, for example, oxides of aluminum, iron, and tin, optionally used in conjunction with an electrically conductive material. Another metal oxide that may be suitable is indium tin oxide (ITO). ITO has a more uniform crystal structure and, therefore, is clear at most coating thicknesses. Alternatively still, the susceptor may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum. In other embodiments, the susceptor may be carbon-based, for example, as disclosed in U.S. Pat. Nos. 4,943,456, 5,002,826, 5,118,747, and 5,410,135. In still other embodiments, the susceptor may interact with the magnetic portion of the electromagnetic energy in the microwave oven. Correctly chosen materials of this type can self-limit based on the loss of interaction when the Curie temperature of the material is reached. An example of such an interactive coating is described in U.S. Pat. No. 4,283,427.

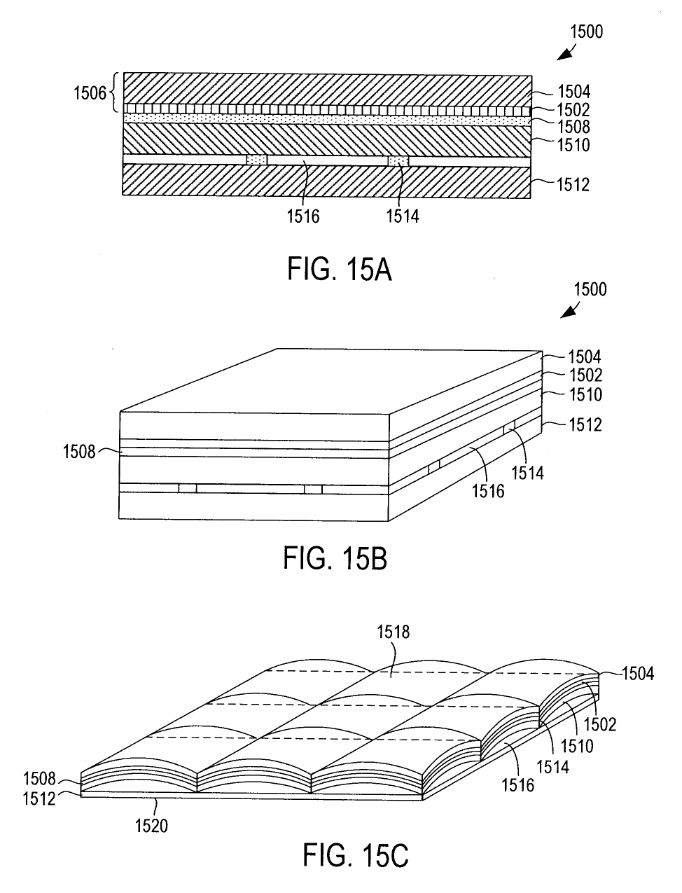

If desired, the susceptor may comprise a portion of a microwave energy interactive insulating material. The insulating material may be used, for example, to form all or a portion of sleeves 726, 838. One example of a microwave energy interactive insulating material 1500 is illustrated schematically in FIGS. 15A-15C. The microwave energy interactive insulating material 1500 includes a thin layer of microwave energy interactive material (i.e., a susceptor) 1502 is supported on a microwave energy transparent substrate, for example, a first polymer film 1504, to define a susceptor film 1506. The microwave energy interactive material 1502 of the susceptor film 1506 is joined with an adhesive 1508 (or otherwise) to a dimensionally stable support 1510, for example, paper. The support 1510 is joined to a second polymer film 1512 using a patterned adhesive 1514 or other material, thereby defining a plurality of closed cells 1516 are formed in the material 1500. The insulating material 1500 may be cut and provided as a substantially flat, multi-layered sheet, as shown in FIG. 15B.

As the microwave energy interactive material 1502 heats upon impingement by microwave energy, water vapor and other gases typically held in the support 1510, for example, paper, and any air trapped in the thin space between the second polymer film 1512 and the support 1510 in the closed cells 1516, expand, as shown in FIG. 15C. The resulting insulating material 1500′ has a quilted or pillowed top surface 1518 and substantially planar bottom surface 1520. When microwave heating has ceased, the cells 1516 typically deflate and return to a somewhat flattened state. Such materials are disclosed in U.S. Pat. No. 7,019,271, U.S. Pat. No. 7,351,942, and U.S. Patent Application Publication No. 2008/0078759 A1, published Apr. 3, 2008. Alternatively, it is contemplated the present constructs and systems may include a microwave energy interactive insulating material that remains inflated after exposure to microwave energy has ceased. Examples of such materials are disclosed in U.S. Pat. No. 7,868,274.

As another example, the microwave energy interactive material may be configured as a foil or high optical density evaporated material having a thickness sufficient to reflect a substantial portion of impinging microwave energy. Such elements typically are formed from a conductive, reflective metal or metal alloy, for example, aluminum, copper, or stainless steel, in the form of a solid “patch” generally having a thickness of from about 0.000285 inches to about 0.005 inches, for example, from about 0.0003 inches to about 0.003 inches. Other such elements may have a thickness of from about 0.00035 inches to about 0.002 inches, for example, 0.0016 inches.

In some cases, microwave energy reflecting (or reflective) elements may be used as shielding elements (e.g., shielding elements 526, 734, 836, 840) where the food item is prone to scorching or drying out during heating. In other cases, smaller microwave energy reflecting elements may be used to diffuse or lessen the intensity of microwave energy. One example of a material utilizing such microwave energy reflecting elements is commercially available from Graphic Packaging International, Inc. (Marietta, Ga.) under the trade name MicroRite® packaging material. In other examples, a plurality of microwave energy reflecting elements may be arranged to form a microwave energy directing element (e.g., directing elements 516, 618, 724) to direct microwave energy to specific areas of the food item. If desired, the loops may be of a length that causes microwave energy to resonate, thereby enhancing the distribution effect. Examples of microwave energy directing elements are described in U.S. Pat. Nos. 6,204,492, 6,433,322, 6,552,315, and 6,677,563.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy. The breaks or apertures may extend through the entire structure, or only through one or more layers. The number, shape, size, and positioning of such breaks or apertures may vary for a particular application depending on the type of construct being formed, the food item to be heated therein or thereon, the desired degree of heating, browning, and/or crisping, whether direct exposure to microwave energy is needed or desired to attain uniform heating of the food item, the need for regulating the change in temperature of the food item through direct heating, and whether and to what extent there is a need for venting.

By way of illustration, a microwave energy interactive element may include one or more transparent areas to effect dielectric heating of the food item. However, such apertures decrease the total microwave energy interactive area. Thus, the relative amounts of microwave energy interactive areas and microwave energy transparent areas must be balanced to attain the desired overall heating characteristics for the particular food item.

In the case of a susceptor, one or more portions of the susceptor may be designed to be microwave energy inactive to ensure that the microwave energy is focused efficiently on the areas to be heated, browned, and/or crisped, rather than being lost to portions of the food item not intended to be browned and/or crisped or to the heating environment. Additionally or alternatively, it may be beneficial to create one or more discontinuities or inactive regions to prevent overheating or charring of the food item and/or the construct including the susceptor. By way of example, the susceptor may incorporate one or more “fuse” elements that limit the propagation of cracks in the susceptor structure, and thereby control overheating, in areas of the susceptor structure where heat transfer to the food is low and the susceptor might tend to become too hot. The size and shape of the fuses may be varied as needed. Examples of susceptors including such fuses are provided, for example, in U.S. Pat. No. 5,412,187, U.S. Pat. No. 5,530,231, U.S. Patent Application Publication No. US 2008/0035634A1, published Feb. 14, 2008, and PCT Application Publication No. WO 2007/127371, published Nov. 8, 2007.

The discontinuities or inactive regions of a susceptor may comprise a physical aperture or void in one or more layers or materials used to form the structure or construct, or may be a non-physical “aperture”. A non-physical aperture is a microwave energy transparent area that allows microwave energy to pass through the structure without an actual void or hole cut through the structure. Such areas may be formed by simply not applying microwave energy interactive material to the particular area, by removing microwave energy interactive material from the particular area, or by mechanically deactivating the particular area (thereby rendering the area electrically discontinuous). Alternatively, the areas may be formed by chemically deactivating the microwave energy interactive material in the particular area, thereby transforming the microwave energy interactive material in the area into a substance that is transparent to microwave energy (i.e., microwave energy inactive). While both physical and non-physical apertures allow the food item to be heated directly by the microwave energy, a physical aperture also provides a venting function to allow steam or other vapors or liquid released from the food item to be carried away from the food item.

As stated above, the microwave energy interactive material (e.g., microwave energy interactive material 102, 512, 516, 526, 614, 618, 714, 724, 734, 814, 836, 840, 1502) may be supported on a polymer film (e.g., polymer film 104, 1504). The thickness of the film typically may be from about 35 gauge to about 10 mil, for example, from about 40 to about 80 gauge, for example, from about 45 to about 50 gauge, for example, about 48 gauge. Examples of polymer films that may be suitable include, but are not limited to, polyolefins, polyesters, polyamides, polyimides, polysulfones, polyether ketones, cellophanes, or any combination thereof. In one specific example, the polymer film may comprise polyethylene terephthalate (PET). Examples of PET films that may be suitable include, but are not limited to, MELINEX®, commercially available from DuPont Teijan Films (Hopewell, Va.), SKYROL, commercially available from SKC, Inc. (Covington, Ga.), and BARRIALOX PET, available from Toray Films (Front Royal, Va.), and QU50 High Barrier Coated PET, available from Toray Films (Front Royal, Va.). The polymer film may be selected to impart various properties to the microwave interactive web, for example, printability, heat resistance, or any other property. As one particular example, the polymer film may be selected to provide a water barrier, oxygen barrier, or any combination thereof. Such barrier film layers may be formed from a polymer film having barrier properties or from any other barrier layer or coating as desired. Suitable polymer films may include, but are not limited to, ethylene vinyl alcohol, barrier nylon, polyvinylidene chloride, barrier fluoropolymer, nylon 6, nylon 6,6, coextruded nylon 6/EVOH/nylon 6, silicon oxide coated film, barrier polyethylene terephthalate, or any combination thereof.

If desired, the polymer film may undergo one or more treatments to modify the surface prior to depositing the microwave energy interactive material onto the polymer film. By way of example, and not limitation, a polymer film used to form a susceptor film (e.g., susceptor film 106, 1506) may undergo a plasma treatment to modify the roughness of the surface of the polymer film. While not wishing to be bound by theory, it is believed that such surface treatments may provide a more uniform surface for receiving the microwave energy interactive material, which in turn, may increase the heat flux and maximum temperature of the resulting susceptor structure. Such treatments are discussed in U.S. Patent Application Publication No. 2010/0213192 A1, published Aug. 26, 2010, which is incorporated by reference herein in its entirety. Other non-conducting substrate materials such as paper and paper laminates, metal oxides, silicates, cellulosics, or any combination thereof, also may be used.

As stated above, the construct may include a paper or paperboard support (e.g., support 108, 1510) that imparts dimensional stability to the structure. The paper may have a basis weight of from about 15 to about 60 lb/ream (lb/3000 sq. ft.), for example, from about 20 to about 40 lb/ream, for example, about 25 lb/ream. The paperboard may have a basis weight of from about 60 to about 330 lb/ream, for example, from about 80 to about 140 lb/ream. The paperboard generally may have a thickness of from about 6 to about 30 mils, for example, from about 12 to about 28 mils. In one particular example, the paperboard has a thickness of about 14 mils. Any suitable paperboard may be used, for example, a solid bleached sulfate board, for example, Fortress® board, commercially available from International Paper Company, Memphis, Tenn., or solid unbleached sulfate board, such as SUS® board, commercially available from Graphic Packaging International, Marietta, Ga. Alternatively, the support may comprise a polymer, for example, CPET.

Various aspects of the present invention may be understood further by way of the following examples, which are not to be construed as limiting in any manner.

### EXAMPLE 1

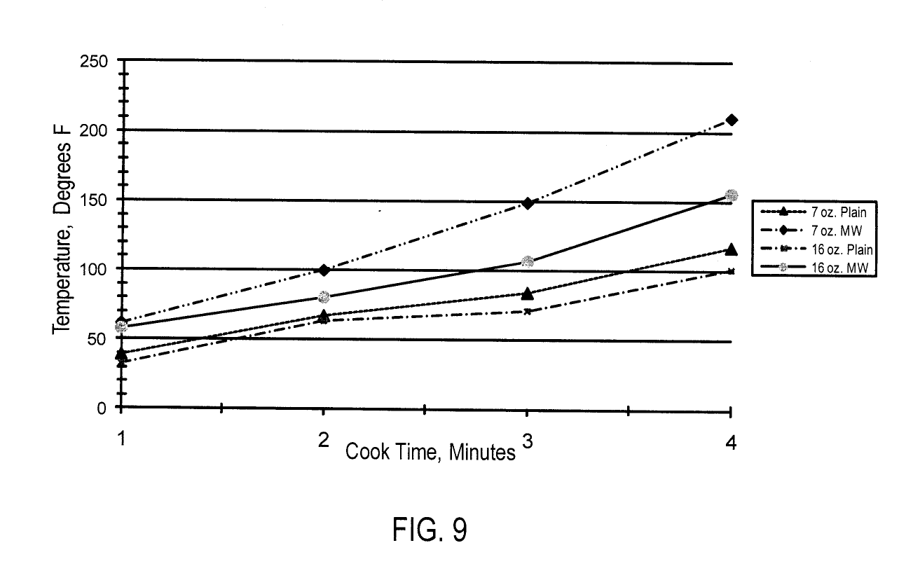

The ability of water in various states to absorb microwave energy was evaluated. Various bowls filled with water were frozen in a freezer maintained at a temperature of about 0° F. The filled bowls were heated in a Panasonic™ 1100 watt microwave oven at full power. At one-minute intervals, the temperature of the upper outer bowl, lower outer bowl, and water/ice were measured using a Luxtron fiber optic probe. The results are presented in Table 6 and FIG. 9.

TABLE 6

| | Time | Upper Bowl | Lower Bowl | Water Temp |
|---|---|---|---|---|
| Bowl Type | (min) | Temp (° F.) | Temp (° F.) | (° F.) |
| 7 oz. Paperboard | 1 | 98 | 153 | 39 |
| | 2 | 109 | 156 | 67 |
| | 3 | 116 | 160 | 84 |
| | 4 | 118 | 168 | 117 |
| | | | | (ice chips) |
| 7 oz. Paperboard | 1 | 96 | 250 | 62 |
| w/QUIKWAVE ® | 2 | 107 | 255 | 100 |
| susceptor | 3 | 110 | 252 | 149 |
| (“MW”) | 4 | 114 | 248 | 210 |
| | | | | (no ice) |
| 16 oz. Paperboard | 1 | 95 | 156 | 37 |
| | 2 | 103 | 148 | 63 |
| | 3 | 111 | 151 | 71 |
| | 4 | 115 | 159 | 101 |
| | | | | (large ice chunk) |
| 16 oz. Paperboard | 1 | 92 | 194 | 58 |
| w/QUIKWAVE ® | 2 | 106 | 186 | 80 |
| susceptor | 3 | 112 | 220 | 107 |
| (“MW”) | 4 | 115 | 222 | 156 |
| | | | | (small ice chunk) |

The results indicate that frozen water is a relatively poor absorber of microwave energy. In contrast, liquid water more effectively converts microwave energy into sensible heat. Furthermore, the frozen water heated more rapidly in the bowls that included the susceptor material, which readily converts microwave energy into sensible heat.

### EXAMPLE 2

Various sandwiches were wrapped in different packaging materials. Campbell Soup™ chicken with rice soup was placed in various constructs. Both food items were frozen to about 0° F. and placed beside each other in a Panasonic™ 1100 watt microwave oven and heated at full power for varying time intervals. The food items then were allowed to stand for about one minute. The temperature of the soup and sandwich were measured using Luxtron fiber optic probe. The quality of the bread was observed. The various materials used, package configurations, heating conditions, and results are presented in FIGS. 10-14 and Table 7, in which:
“Chicken Caesar” refers to a Panera Chicken Caesar sandwich;
“Chicken on . . . ” refers to a sandwich prepared from Panera bread with 3 ounces of Louis Rich grilled chicken strips;
“PET” refers to 48 gauge polyethylene terephthalate film;
“MPET” refers to 48 gauge metallized polyethylene terephthalate film;
“excellent” results refers to thorough heating of the soup and proper heating, browning, and crisping of the sandwich;
“very good” results refers to thorough heating of the soup and sandwich, but somewhat insufficient browning and/or crisping of the sandwich bread;
“good” results refers to thorough heating of the soup, but insufficient heating, browning, and/or crisping of the sandwich;
“poor” results refers to insufficient heating of the soup and/or overheating, over-browning, or over-crisping of the sandwich; and
“NA” results refer to results that are not available due to product failure, scorching of the food items, or some combination thereof;
FIGS. 10-12 present top plan views of blanks used to form trays used in the various examples, with the metallic shielding elements indicated with hatch marks, modified as indicated in Table 7, and where the tray was generally shaped as shown in FIG. 13; and
FIG. 14 depicts the pattern of the segmented foil, which was superposed with a susceptor, as used in various examples as indicated in Table 7.

The results indicate that the package of the present invention may be used effectively to heat multiple food items to their desired respective serving temperatures, including liquid food items, within about the same amount of time.

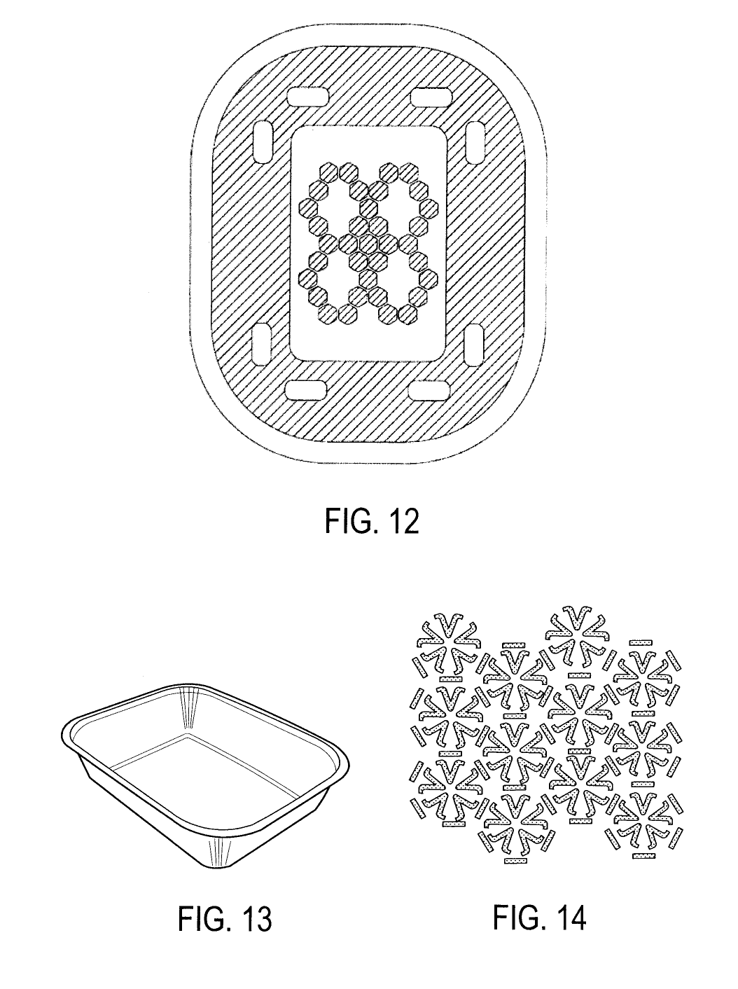

TABLE 7

| | | | | | | Full | Hold | | | | |
|---|---|---|---|---|---|---|---|---|---|---|---|
| | Soup | | Sandwich | | | power | time | Soup | Bread | Meat | Sandwich |
| Test | (g) | Bowl capacity/type | Type | (g) | Packaging | (s) | (s) | (F.) | (F.) | (F.) | quality |
| 1 | 212 | 16 oz SBS/PET | Chicken | 251 | QUILTWAVE ® | 540 | 60 | 148-154 | 200 | 200 | Poor |
| | | | Caesar | | susceptor pouch | | | | | | |
| 2 | 216 | 16 oz SBS/PET | Chicken | 252 | Multi-ply paper | 540 | 60 | 155-165 | 199 | 200 | Poor |
| | | | Caesar | | wrap (non-interactive) | | | | | | |
| 3 | 159 | 9 oz SBS/PET | Chicken | 240 | Multi-ply paper | 450 | 60 | 165-178 | 200 | 200 | Poor |
| | | | Caesar | | wrap (non-interactive) | | | | | | |
| 4 | 159 | 9 oz SBS/MPET | Chicken | 219 | Two opposed 900 cm³ | 265 | NA | NA | NA | NA | NA |
| | | | Caesar | | MICRORITE ® trays | | | | | | |
| 5 | 150 | 9 oz SBS/MPET | Chicken | 240 | Sandwich in PET/paper/PET | 310 | NA | 175-177 | 122-175 | NA | Excellent |
| | | | Caesar | | pouch, pouch in two opposed | | | | | | |
| | | | | | 1000 cm³ MICRORITE ® | | | | | | |
| | | | | | trays (FIG. 10) w/Al foil | | | | | | |
| | | | | | added to bottom of lower tray | | | | | | |
| 6 | 248 | 16 oz MICRORITE ® | Chicken | 240 | Sandwich in PET/paper/PET | 390 | 60 | 165 | 146-177 | 80-163 | Excellent |
| | | susceptor (FIG. 11) | Caesar | | pouch, pouch in two opposed | | | | | | |
| | | | | | 1000 cm³ MICRORITE ® | | | | | | |
| | | | | | trays (FIG. 10) w/Al foil | | | | | | |
| | | | | | added to bottom of lower tray | | | | | | |
| 7 | 151 | 9 oz SBS/MPET | Chicken | 120 | Sandwich in PET/paper/PET | 240 | 60 | 168-173 | 85-180 | 79-128 | Poor |
| | | | Caesar | | pouch, pouch in two opposed | | | | | | |
| | | | | | 400 cm³ MICRORITE ® trays | | | | | | |
| 8 | 240 | 16 oz MICRORITE ® | Chicken | 235 | Sandwich in PET/paper/PET | 390 | 60 | 180 | 182 | 28 | NA |
| | | susceptor (FIG. 11) | Caesar | | pouch, pouch in 900 cm³ | | | | | | |
| | | | | | MICRORITE ® molded rim | | | | | | |
| | | | | | tray (FIG. 11) w/paperboard | | | | | | |
| | | | | | sleeve w/Al foil patch in | | | | | | |
| | | | | | center of top | | | | | | |
| 9 | 222 | 16 oz susceptor w/ | Chicken | 234 | Sandwich in PET/paper/PET | 390 | 60 | 175-185 | 140-164 | 32 | NA |
| | | QUILTWAVE ® | Caesar | | pouch, pouch in 900 cm³ | | | | | | |
| | | susceptor around outside | | | MICRORITE ® molded rim | | | | | | |
| | | | | | tray (FIG. 11) w/paperboard | | | | | | |
| | | | | | sleeve w/Al foil patch in | | | | | | |
| | | | | | center of top | | | | | | |
| 10 | 222 | 16 oz MICRORITE ® | Chicken | 234 | Sandwich in PET/paper/PET | 390 | 60 | 148-156 | 100-150 | 31-105 | Good |
| | | susceptor (FIG. 11) | Caesar | | pouch, pouch in two opposed | | | | | | |
| | | | | | 1000 cm³ MICRORITE ® | | | | | | |
| | | | | | trays (FIG. 10) | | | | | | |
| 11 | 232 | 16 oz MICRORITE ® | Chicken | 260 | Sandwich in PET/paper/PET | 390 | 60 | 145-157 | 90-112 | 27-45 | Good |
| | | susceptor (FIG. 11) | Caesar, | | pouch, pouch in two opposed | | | | | | |
| | | | center | | 400 cm³ MICRORITE ® trays | | | | | | |
| | | | pieces | | (FIG. 12), w/one 1 in. hole | | | | | | |
| | | | | | cut in foil at center of trays | | | | | | |
| 12 | 232 | 16 oz susceptor | Chicken | 260 | Sandwich in PET/paper/PET | 390 | 60 | 145-149 | 108-170 | 62-170 | Excellent |
| | | | Caesar, | | pouch, pouch in two opposed | | | | | | |
| | | | end | | 400 cm³ MICRORITE ® trays | | | | | | |
| | | | pieces | | (FIG. 12), w/three 1 in. | | | | | | |
| | | | | | holes cut in foil along | | | | | | |
| | | | | | center axis of trays | | | | | | |
| 13 | 205 | 16 oz susceptor | Chicken | 270 | Sandwich in PET/paper/PET | 390 | 60 | 163-165 | 195-200 | 193-200 | Excellent |
| | | | on ciabatta | | pouch, pouch in two opposed | | | | | | |
| | | | | | 400 cm³ MICRORITE ® trays | | | | | | |
| | | | | | (FIG. 12), w/three 1 in. | | | | | | |
| | | | | | holes cut in foil along | | | | | | |
| | | | | | center axis of trays | | | | | | |
| 14 | 146 | 9 oz SBS/MPET | Chicken | 162 | Sandwich in PET/paper/PET | 300 | 60 | 157-160 | 179-202 | 192-199 | Very good |
| | | | on rye | | pouch, pouch in two opposed | | | | | | |
| | | | | | 400 cm³ MICRORITE ® trays | | | | | | |
| | | | | | (FIG. 12), w/three 1 in. | | | | | | |
| | | | | | holes cut in foil along | | | | | | |
| | | | | | center axis of trays | | | | | | |
| 15 | 158 | 9 oz SBS/MPET | Chicken | 154 | Sandwich in PET/paper/PET | 300 | 60 | 165-167 | 199 | 180-192 | Very good |
| | | | on wheat | | pouch, pouch in two opposed | | | | | | |
| | | | | | 400 cm³ MICRORITE ® trays | | | | | | |
| | | | | | (FIG. 12), one 1 in. hole | | | | | | |
| | | | | | cut in foil along center of | | | | | | |
| | | | | | trays | | | | | | |

Although certain embodiments of this invention have been described with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention as defined in the appended claims. The detailed description set forth herein is not intended nor is to be construed to limit the present invention or otherwise to exclude any such other embodiments, adaptations, variations, modifications, and equivalent arrangements of the present invention.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific aspects, it is to be understood that this detailed description is only illustrative and exemplary of the present invention and is made merely for purposes of providing a full and enabling disclosure of the present invention. The detailed description set forth herein is not intended nor is to be construed to limit the present invention or otherwise to exclude any such other embodiments, adaptations, variations, modifications, and equivalent arrangements of the present invention.

What is claimed is:

1. A microwave heating construct in combination with a liquid food item, the liquid food item initially being in a frozen state, the microwave heating construct being for heating the frozen liquid food item to a desired serving temperature in a microwave oven, the construct comprising:
a cavity containing the frozen liquid food item; and
microwave energy interactive material adjacent to the cavity, the microwave energy interactive material being operative as a susceptor for converting at least a portion of impinging microwave energy into thermal energy, wherein the susceptor is for thawing the frozen liquid food item to heat the frozen liquid food item to the desired serving temperature more quickly than a microwave heating construct without the susceptor.

2. The combination of claim 1, wherein the thermal energy is for thawing the frozen liquid food item, the thawed liquid food item having a higher dielectric constant and a higher loss tangent than the frozen liquid food item.

3. The combination of claim 1, further comprising a plurality of metal foil segments configured to direct microwave energy towards a central bottom area of the liquid food item.

4. The combination of claim 1, further comprising a plurality of microwave energy transparent areas circumscribed by the microwave energy interactive material.

5. A microwave heating construct for concurrently heating a first food item and a second food item in a microwave oven, the first food item and the second food item each being frozen at a respective initial temperature and having a respective required heating time to reach a respective desired serving temperature that is higher than the respective initial temperature, wherein the first food item is substantially a liquid or semi-liquid at its desired serving temperature, and the second food item is substantially a solid at its desired serving temperature, the microwave heating construct comprising:
a susceptor for being in proximity to the first food item, the susceptor being for generating heat at an interface with the first food item to reduce the required heating time of the first food item relative to heating the first food item without the susceptor; and
at least one microwave energy interactive element for altering the required heating of the second food item so that the first food item and the second food item are heated to their respective desired serving temperatures in substantially the same amount of time.

6. The microwave heating construct of claim 5, wherein the microwave energy interactive element comprises a plurality of metallic foil segments arranged to direct microwave energy towards at least a portion of the second food item so that the required heating time of the second food item decreases relative to heating the second food item without the plurality of metallic foil segments.

7. The microwave heating construct of claim 5, wherein the microwave energy interactive element comprises a metallic foil patch for reducing the transmission of microwave energy to at least a portion of the second food item so that the required heating time of the second food item increases relative to heating the second food item without the metallic foil patch.

8. The microwave heating construct of claim 5, further comprising a plurality of metallic foil segments arranged to direct microwave energy towards at least a portion of the first food item.

9. The microwave heating construct of claim 5, further comprising a plurality of microwave energy transparent areas circumscribed by the susceptor.

10. The microwave heating construct of claim 5, further comprising a susceptor for browning and/or crisping a surface of the second food item.

11. A microwave heating construct in combination with a first food item and a second food item, the microwave heating construct being for concurrently heating the first food item and the second food item in a microwave oven, wherein the first food item and the second food item are each frozen at a respective initial temperature and have a respective required heating time to reach a respective desired serving temperature that is higher than the respective initial temperature, and wherein the first food item is substantially a liquid or semi-liquid at its desired serving temperature, and the second food item is substantially a solid at its desired serving temperature, the microwave heating construct comprising:
a first compartment containing the first food item and a second compartment containing the second food item, the first compartment and the second compartment each comprising microwave energy interactive material, wherein
the microwave energy interactive material of the first compartment comprises a susceptor for reducing the required heating time of the first food item relative to heating the first food item without the susceptor, and
the microwave energy interactive material of the second compartment is configured to alter the rate of heating the second food item so the second food item is heated to its desired serving temperature when the first food item is heated to its desired serving temperature.

12. The combination of claim 11, wherein the microwave energy interactive material of the first compartment further comprises a plurality of metallic foil segments arranged to direct microwave energy towards at least a portion of the first food item.

13. The combination of claim 11, wherein the microwave energy interactive material of the first compartment circumscribes a plurality of microwave energy transparent areas.

14. The combination of claim 11, wherein the microwave energy interactive material of the second compartment comprises a plurality of metallic foil segments arranged to direct microwave energy towards at least a portion of the second food item.

15. The combination of claim 11, wherein the microwave energy interactive material of the second compartment comprises a metallic foil patch configured to reduce the transmission of microwave energy to at least a portion of the second food item.

16. The combination of claim 11, wherein the microwave energy interactive material of the second compartment comprises a susceptor for browning and/or crisping a surface of the second food item.

17. The combination of claim 11, further comprising an overwrap overlying at least one of the first compartment and the second compartment, wherein the overwrap comprises microwave energy interactive material.

18. The combination of claim 17, wherein the microwave energy interactive material of the overwrap is configured to overlie the second compartment.

19. The combination of claim 18, wherein the microwave energy interactive material of the overwrap comprises at least one of
a metallic foil patch for reducing the transmission of microwave energy to at least a portion of the second food item, and
a plurality of metallic foil segments arranged to direct microwave energy towards at least a portion of the second food item.

20. The combination of claim 11, further comprising a sleeve for receiving the first compartment and the second compartment, wherein the sleeve comprises microwave energy interactive material.

21. The combination of claim 20, wherein the microwave energy interactive material of the sleeve is configured to overlie the second compartment.

22. The combination of claim 21, wherein the microwave energy interactive material of the sleeve comprises at least one of
a metallic foil patch for reducing the transmission of microwave energy to at least a portion of the second food item, and
a plurality of metallic foil segments arranged to direct microwave energy towards at least a portion of the second food item.

23. The combination of claim 21, wherein the first compartment comprises a cup or bowl.

24. The combination of claim 23, wherein the microwave energy interactive material of the first compartment is mounted to the cup or bowl.

25. The combination of claim 21, wherein the second compartment comprises a sleeve, pouch, or wrap.

26. The combination of claim 25, wherein the microwave energy interactive material of the second compartment is mounted to the sleeve, pouch, or wrap.

27. The combination of claim 25, wherein the sleeve, pouch, or wrap comprises a microwave energy interactive insulating material.

28. The combination of claim 11, wherein the first food item comprises a beverage, soup, stew, sauce, gravy, condiment, compote, pudding, or custard.

29. The combination of claim 11, wherein the second food item comprises a dough-based or breaded food item.

30. The combination of claim 11, wherein the first food item comprises soup and the second food item comprises a sandwich.

31. The combination of claim 11, wherein the first food item comprises ketchup and the second food item comprises French fries.
